(19) United States
(12) Patent Application Publication
(10) Pub. No.: US 2026/0211387 A1
(43) Pub. Date: Jul. 23, 2026

(54) System and Method for Detecting and Managing Irreversible State Transitions Using Collapse- Based Modeling

(71) Applicant: Larry Lim Kheng Cheong, Singapore (SG)

(72) Inventor: Larry Lim Kheng Cheong, Singapore (SG)

(21) Appl. No.: 19/571,508

(22) Filed: Mar. 19, 2026

Related U.S. Application Data
(63) Continuation-in-part of application No. 19/173,849, filed on Apr. 9, 2025.

(51) Int. Cl. G05B 13/04

(52) U.S. Cl. CPC G05B 13/048

(57) ABSTRACT

A system and method for detecting, predicting, and managing irreversible state transitions in complex systems using collapse-based modeling. The system computes a collapse metric derived from current system states, historical trajectories, interaction effects, and dynamic acceleration behavior. A multi-dimensional collapse surface is generated through parameter simulation to identify stable and unstable regions. A decision engine produces control actions, including continuation, adjustment, or termination, with asymmetric weighting to prioritize avoidance of irreversible negative outcomes. The system enables real-time monitoring and intervention across domains including drug discovery, biological systems, financial risk management, and engineered systems, providing a deterministic framework for managing threshold-driven transitions.

### FIELD OF THE INVENTION

The invention relates to computational systems for analyzing complex dynamic systems and detecting threshold-based transitions. Specifically, it describes a collapse-based system for modeling irreversible state changes using historical dependence, interaction dynamics, and decision-driven control mechanisms.

### BACKGROUND OF THE INVENTION

Modern computational systems, including artificial intelligence and predictive analytics, primarily operate through statistical approximation and continuous interpolation. These systems are effective in stable regimes but fail to detect discontinuous transitions, irreversible events, and threshold-driven system collapse.

Many real-world systems—including biological processes, drug development pipelines, financial markets, and engineered systems—exhibit non-linear behavior characterized by:
sudden state transitions;
path-dependent dynamics (hysteresis);
irreversible outcomes;
non-linear amplification effects.

Existing approaches do not adequately model these behaviors. They lack mechanisms to incorporate historical state dependence, detect collapse boundaries, or generate actionable decisions to prevent irreversible system failure.

There is therefore a need for a computational system that:
models system evolution using both present and historical states;
detects proximity to irreversible transitions;
maps stability boundaries across parameter spaces; and
generates control actions to manage system behavior.

### SUMMARY OF THE INVENTION

The invention discloses a system comprising:
A collapse metric computation engine that evaluates system state using current and historical data;
A memory encoding mechanism that captures path-dependent system evolution;
A collapse surface mapping module that identifies stability and instability regions;
A threshold detection module that detects proximity to irreversible transitions; and
A decision engine that generates control actions based on collapse risk.

The system provides a deterministic framework for managing complex systems by identifying and responding to collapse conditions.

### DETAILED DESCRIPTION OF THE INVENTION

### 1. Collapse Metric Computation

A collapse metric C(t) is computed based on system variables:

$$C ( t ) = α \cdot ‖ X ( t ) ‖ + β \cdot ‖ M ( t ) ‖ + γ \cdot I ( t ) + δ \cdot ‖ A ( t ) ‖$$

Where:
X(t) represents the current system state;
M(t) represents accumulated historical states;
I(t) represents interaction effects between variables;
A(t) represents acceleration (second-order change);
α, β, γ, δ are weighting coefficients.

This metric quantifies proximity to instability or collapse.

### 2. Memory Encoding and Hysteresis

Historical dependence is incorporated using:

$$M ( t ) = λ \cdot M ( t - 1 ) + X ( t )$$

Where:
λ is a decay factor;
historical trajectories are stored as rolling memory structures.

This enables identical current states to produce different outcomes depending on prior system evolution.

### 3. Interaction and Acceleration Components

Interaction effects are computed as:

$$I ( t ) = {X ( t )}^{T} WX ( t )$$

Where W is an interaction matrix.

Acceleration is computed as:

$$A ( t ) = X ( t ) - 2 X ( t - 1 ) + X ( t - 2 )$$

These components capture non-linear amplification and dynamic instability.

### 4. Collapse Surface Mapping

The system generates collapse surfaces by:
simulating parameter variations;
computing collapse metrics across scenarios;
identifying stable, unstable, and transition regions.

This produces a multi-dimensional representation of system behavior.

### 5. Threshold Detection

Collapse thresholds are identified by:
comparing collapse metric values against predefined or adaptive thresholds;
detecting rapid increases in collapse metric gradients;
identifying non-linear escalation patterns.

### 6. Decision Engine

The system generates control actions:
CONTINUE when system remains stable;
ADJUST when approaching instability;
TERMINATE when collapse risk exceeds threshold.

The decision engine applies asymmetric weighting to prioritize avoidance of irreversible outcomes.

### 7. Execution of Control Actions

Control actions may include:
halting computational or experimental processes;
modifying system parameters;
transmitting signals to external systems;
triggering automated shutdown mechanisms.

### 8. Example Applications

Drug Discovery: Early detection of toxicity thresholds in drug candidates using collapse metrics derived from biological data.

Financial Systems: Detection of instability regimes and prevention of catastrophic losses through collapse-based risk modeling.

Biological Systems: Monitoring of physiological transitions and early detection of failure conditions.

### ADVANTAGES

Detection of non-linear threshold transitions;
Incorporation of historical system behavior;
Real-time identification of instability;
Deterministic decision-making;
Applicability across multiple domains.

### ALTERNATIVE EMBODIMENTS

The system may be extended to include:
adaptive threshold mechanisms;
domain-specific parameter tuning;
integration with machine learning models;
distributed or cloud-based implementations;
hybrid architectures combining statistical and collapse-based models.

1. A system for detecting and managing irreversible state transitions in complex systems, comprising:
(a) a data ingestion module configured to receive system state data;
(b) a computation module configured to compute a collapse metric based on current system states and historical data;
(c) a memory module configured to store historical system trajectories;
(d) a collapse surface mapping module configured to simulate parameter variations and identify regions of stability and instability; and
(e) a decision module configured to generate control actions based on said collapse metric and detected thresholds.

2. The system of claim 1, wherein the collapse metric incorporates historical state dependence.

3. The system of claim 1, wherein identical current system states produce different outputs based on historical trajectories.

4. The system of claim 1, wherein the collapse metric includes interaction terms between system variables.

5. The system of claim 1, wherein the collapse metric includes second-order derivatives representing acceleration.

6. The system of claim 1, wherein collapse surface mapping identifies transition boundaries between stable and unstable regions.

7. The system of claim 1, wherein threshold detection includes identifying rapid changes in collapse metric gradients.

8. The system of claim 1, wherein the decision module generates control actions selected from continuation, adjustment, and termination.

9. The system of claim 1, wherein the decision module applies asymmetric weighting to prioritize avoidance of irreversible outcomes.

10. The system of claim 1, wherein control actions include halting a process, modifying system parameters, or triggering system shutdown.

11. A method for detecting and managing irreversible state transitions, comprising:
(a) receiving system state data;
(b) storing historical data;
(c) computing a collapse metric;
(d) detecting threshold conditions; and
(e) generating control actions.

12. The method of claim 11, further comprising simulating parameter variations to generate collapse surfaces.

13. A non-transitory computer-readable medium storing instructions that, when executed by a processor, cause the processor to perform the method of claim 11.

14. The system or method of any preceding claim, wherein the system is applied to drug discovery, biological systems, financial systems, or engineered systems.
